(19) United States
(12) Patent Application Publication
(10) Pub. No.: US 2007/0298365 A1
(43) Pub. Date: Dec. 27, 2007

(54) Anchorage preparing buccal tube

(76) Inventor: Tian-Min Xu, Haidian (CN)

Correspondence Address: MORRISON & FOERSTER LLP, 425 MARKET STREET, SAN FRANCISCO, CA, 94105-2482, US

(21) Appl. No.: 11/823,241

(22) Filed: Jun. 26, 2007

(30) Foreign Application Priority Data
Jun. 27, 2006 (CN) 200610089440.4

(51) Int. Cl. A61C 3/00

(52) U.S. Cl. 433/17

(57) ABSTRACT

The present invention relates to a novel anchor-preparing buccal tube. The buccal tube finds use in orthodontic treatment. The buccal tube described herein has at least one passage for receiving a main arch wire. The buccal tube can also include multi-passages so that clinicians have the option to insert the main arch wire into one of the passages to tip back the molar(s) or prevent the molar(s) from tipping forward. As such, anchorage is enhanced during orthodontic treatment. The novel buccal tube provides for a tip-back angle with a light-force and aesthetically pleasing nickel-titanium wire used in modern orthodontics to cause a tip back movement of the molar so that an anchorage preparation is possible without the use of stainless steel wire.

### CROSS-REFERENCE TO RELATED APPLICATIONS

This application claims the benefit of the filing date of a prior foreign application as specified in 35 U.S.C. § 119(a) through (d) and (f), § 172 and §365 (a) and (b), of foreign application number 200610089440.4, filed on Jun. 27, 2006 in China, which is hereby incorporated by reference in the present disclosure in its entirety.

### FIELD OF THE INVENTION

The present invention relates to a novel anchor-preparing buccal tube. The buccal tube finds use in orthodontic treatment wherein it provides for enhanced anchorage.

### BACKGROUND OF THE INVENTION

Teeth are surrounded on top by gum tissue, also called gingiva. Under the gum tissue, the periodontal membrane, sometimes called the periodontal ligament (PDL) encases the bottom portion of the tooth. Next to that lies the alveolar bone. Teeth move due to forces being applied to the teeth. These forces are transmitted to the bone. In order to successfully move teeth without damage, very light forces are applied over a long period of time. The more the teeth require to be moved, the longer the treatment will take. When braces put pressure on the teeth, the periodontal membrane stretches on one side and is compressed on the other. This loosens the tooth. The bone then melts on the pressure side and grows new bone on the other side. Thus, the bone grows in to support the tooth in its new position. As such, the teeth move through the bone.

The teeth are aligned in the bone in the shape of an arch. A long term stability can only be achieved if the original shape and size of the lower dental arch is maintained. The force used to move the teeth is applied with archwires. The teeth move when the arch wire puts pressure on the brackets and teeth. Sometimes, springs or rubber bands are used exert more force in a specific direction. Braces exert constant pressure, which over time, move teeth into their proper positions. Sometimes patients may need to wear headgear to keep certain teeth from moving. The components of typical braces include brackets which are attached to the teeth and serve to fasten the arch wire; an arch wire (metal wire) that is attached to the brackets to move the teeth; and a buccal or molar tube which is a small metal part that is affixed or welded on the outside of a molar band and which contains an opening or slot to hold, among other things, the arch wire.

Commonly, an orthodontic treatment is conducted by the following steps. First, a bracket is attached onto the surface of tooth to be treated by an adhesive and the like. The bracket is formed with a groove for being engaged with an arch wire. In this state, the arch wire applies a pushing force, a pulling force, a twisting force onto the tooth via the bracket. Due to the application of the force, the tooth is moved to a desired position in a desired direction. There is also a bracket with a hook. When two or more teeth are respectively provided with a bracket with a hook, the brackets are connected to each other by putting a rubber ring or a spring around the hooks, and at the same time, an arch wire is engaged to the groove of the brackets. In this state, an orthodontic force is applied to the tooth to be treated by the arch wire and the rubber ring, thereby moving the tooth to the desired position in a desired direction (see U.S. Pat. No. 6,095,808).

Buccal tubes for molar teeth are used for housing the final sections of orthodontic archwires associated with numerous orthodontic aids corresponding to each tooth. Such orthodontic aids exert strength onto the teeth. The buccal tubes are fixed directly on the teeth with adhesive means or orthodontic bands consisting of metallic bands surrounding each tooth, to which buccal tubes are welded. When positioning the tubes, it can be difficult to orientate them in relation to each tooth and to the orthodontic archwire which is to be supported. Buccal tubes in orthodontics often have one main passage for the main arch wire. Some buccal tubes have a round passage for the headgear or lip bumper while others have a rectangular cross-section passage for an auxiliary arch.

For example, an orthodontic buccal tube can have a first passage for receiving a main arch wire, a second passage for receiving either a lip bumper or a facebow, and a third passage for receiving an auxiliary or segmented arch wire. The second passage can include an enlarged, generally frustoconical mesial entrance, and the third passage can include a mesial opening that may be located partially in the enlarged entrance. As such, the third passage can be spaced relatively close to the second passage while the enlarged mesial entrance of the second passage facilitates the insertion of the facebow or the lip bumper (see U.S. Pat. No. 5,151,028).

Buccal tubes are classified as single-, double- and triple tubes according to the number of passages they include. In double and triple tubes the passages are usually almost parallel to each other in a so-called “sagittal plane”. The sagittal plane describes a centric plane the essentially divides the human head into equal parts in orthodontics, i.e., equal right and left parts. Traditionally, the angle of a passage in the sagittal plane is 5° for upper first molars and 2° for lower first molars in order to position molars normally (see L. F. Andrews, Six Keys to Normal Occlusion, Am. J. Orthod. (1972), 62(3):296-309; and The Straight Wire Appliance, Br. J Orthod. (1979), 6(3):125-43; and Straight Wire: The Concept and Appliance, San Diego, 1989, LA, Wells). When bonding the buccal tube parallel to the molar occlusal plane, the angle of the passage in the sagittal plane can also be 0° for both, the upper and the lower molars for the same purpose.

The headgear is a device to push the molars backward or prevent them from moving forward by using the neck or the occipital skeleton as an anchorage. A typical scenario is a case where some teeth are extracted, and front teeth are being retracted (pulled backward). When extraction spaces are being closed, the teeth behind the extraction space slide forward and the teeth in front of the space slide backward. In most situations, to align irregular teeth or reduce protrusion of anterior teeth, posterior teeth should not come forward and the headgear serves to hold them back (maintain anchorage).

Since the auxiliary arch is not widely used, the typical double tubes are comprised of one rectangular cross-section passage for the main arch and one round passage for the headgear. Another anchorage method, used to prevent molars from moving forward employs the “anchorage preparation”. The original anchorage preparation is achieved by making a tip-back bend on a stainless steel main arch wire as in the Tweed-Merrifield technique. This technique consists of bending the wire to all necessary adjustments and not depending on prefabricated average adjustments. The Tweed-Merrifield technique is believed to be superior in both long term stability and esthetics to the common practice of using prefabricated wires with pre-adjusted brackets.

It is a natural phenomenon that human teeth move forward during their life time. The occlusal force is believed to contribute to this kind of teeth movement. When an anterior tooth is lost, posterior teeth more easily tip forward. This explains why molars tip forward especially in extraction cases. With the use of braces and headgear, the molars can be tipped back at the early stage of the orthodontic treatment. This is believed to enhance the resistance of the molars to move forward during a later stage of the treatment. With respect to materials, nickel-titanium wires (Ni—Ti wires) are now widely used as main arch wires during the early stage of an orthodontic treatment because of their light-force nature. Generally, modern techniques do not use stainless steel wire until the later stage (MBT, Damon, etc.) of the treatment. Nickel-titanium (Ni—Ti) wires can provide the needed force for teeth movement, but it can be difficult to achieve a permanent bend with this kind of light-force wire. Before Ni—Ti wire was used in orthodontics, physicians used stainless steel wire which is easy to bend (i.e., put permanent bends in it). But when Ni—Ti wire came into use, physicians realized that it is so flexible that it can provide a very light force to align teeth. However, Ni—Ti wire is difficult to bend, and even if a bend is temporarily achieved, it is difficult to keep the bend because Ni—Ti wire has a so-called shape memorized character (unless the bend is made during special temperature conditions). More specifically, Ni—Ti wire is a very flexible wire, wherein the modulus of elasticity or stress/strain ratio is quite low and the elastic limit is so large that it almost always bounces back when it is bend unless it is heat treated. However, when it is heat treated it loses its elasticity and cannot move tooth. On the other hand, a tip-back bend or anchorage preparation cannot be used in most early stages during the treatment because it causes the molars to tip forward (this is especially true for extraction cases). Thus, there is clearly a need in the art for an orthodontic design that provides the angle (originally provided by the tip-back bend with stainless steel wire), so that un-bent Ni—Ti wires can also provide tip-back effects on molars.

### BRIEF SUMMARY OF THE INVENTION

The present invention provides a solution to a long-felt need in the art, namely that a tip-back bend cannot be achieved through the use of standard nickel-titanium or similar light-force wires, particularly, when employing a method wherein the wires are adjusted by hand. Thus, the invention provides a novel anchor-preparing buccal tube which provides the angle of the tip-back bend in the passage of the tube so that the un-bent Ni—Ti wire can provide tip-back effects on molars. If this design is applied to premolars, the same tip-back effects are achieved on pre-molars.

The present invention provides an anchor-preparing buccal tube which has at least one passage with an at least −3° γ angle between a molar occlusal plane and the passage. In one embodiment, the γ angle is between about −3° and about −45°. In another embodiment, the γ angle is between about −5° and about −15°. In addition, the buccal tube can include more than one passage.

The invention further encompasses a buccal tube with a passage with an at least −3° γ angle between a molar occlusal plane and the passage, wherein the passage has an anti-rotation angle of about 0° to about 30° between the passage and the buccal side of a molar in a horizontal plane. The buccal tube can include more than one such passage. In one embodiment, the passage is cylindrical. In another embodiment, the passage is rectangular. In another embodiment, the rectangular passage has a torque angle θ of about 0° to about −35°.

### BRIEF DESCRIPTION OF THE DRAWINGS

The present invention is best understood when read in conjunction with the accompanying figures, which serve to illustrate the preferred embodiments. It is understood, however, that the invention is not limited to the specific embodiments disclosed in the Figures.

FIG. 1 depicts a cut-away view of a buccal side of an upper-molar buccal tube with two passages. The depicted example is a double tube with rectangular passages, wherein the two passages are seen from the buccal view of an upper molar tooth. The angle that is shown between the vertical cross-section of the passage and the perpendicular line of the occlusal plane is the γ angle. The γ angle of passage 1 is −5°. The γ angle of passage 2 is −15°. The two passages cross in the front. “3” is a hook for various elastic devices and materials (wires, etc.) to pull anterior teeth backward. The hook also serves as a directional mark for the orthodontist.

FIG. 2 shows a left-side view of FIG. 1 from the front side of the buccal tube. The cross-sections of passages 1 and 2 are in rectangular shape. The angle shown between the side of the passage facing the molar and the buccal side of the molar tooth is the torque angle θ. The torque angle θ is −8° in this example. “3” is a hook for various elastic devices and materials (supra).

FIG. 3 shows a double tube of a lower molar buccal tube. The passages 4 and 5 are shown from the buccal side of a molar. In this example, the γ angle of passage 4 is −15° and the γ angle of passage 5 is −3°. The two passages cross in the front and the anterior opening of the tube which is bell-mouthed. “3” is a hook for various elastic devices and materials (supra).

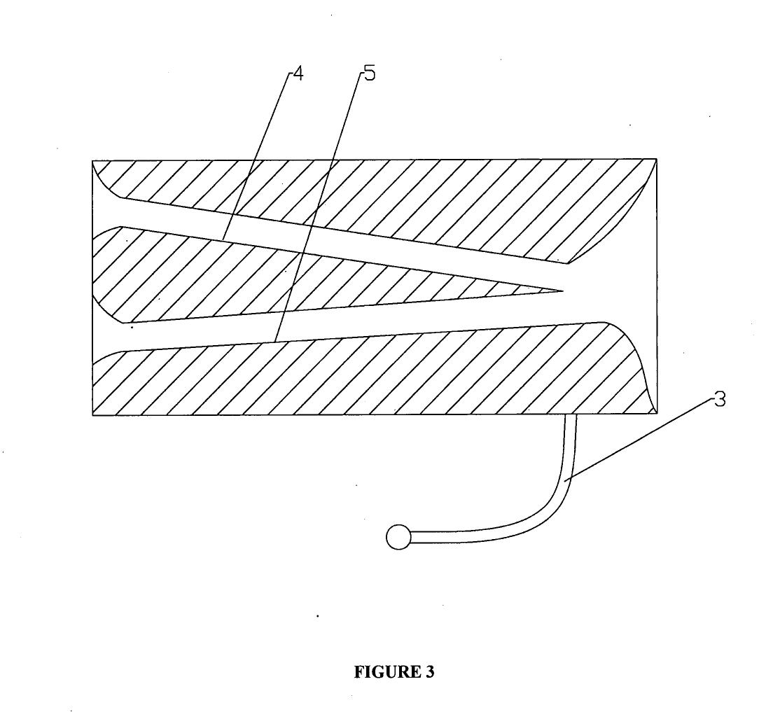

FIG. 4 depicts another buccal tube. In this example, passages 6 and 7 of this lower buccal tube do not cross within the tube but their extensions meet in front of the tube in the saggital plane. The γ angles of passages 6 and 7 are −9° and 0°, respectively. “3” is a hook for various elastic devices and materials (supra).

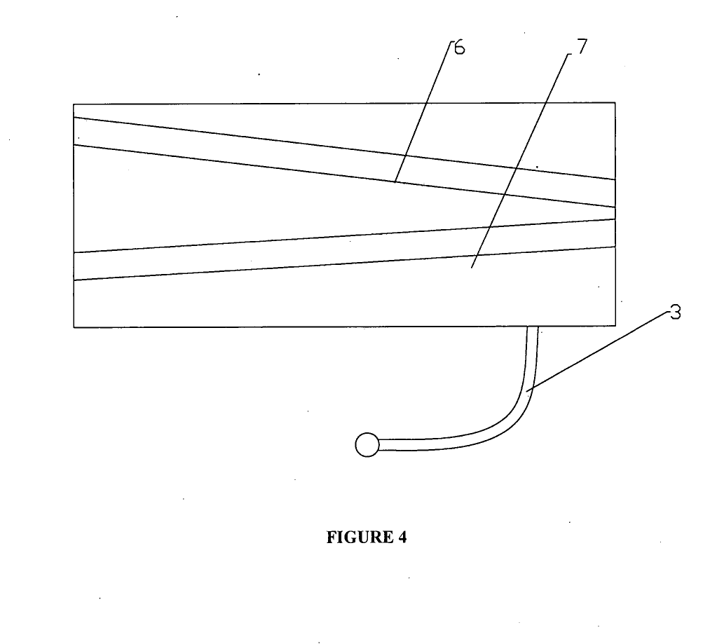

FIG. 5 shows the same buccal tube as in FIG. 4 wherein both passages of 6 and 7 have a 5° anti-rotation angle as depicted. “3” is a hook for various elastic devices and materials (supra).

FIG. 6 illustrates another example of a buccal tube with more then two passages. In this example, three passages can be seen from the buccal view of an upper molar tube. The γ angles of the three passages 8, 9, 10 are −30°, −15° and −5°, respectively. The starting Ni—Ti wire inserts into passage 8. Stiffer wires or wires of a larger size insert into passage 9. The largest or stiffest wire inserts into passage 10. “3” is a hook for various elastic devices and materials (supra).

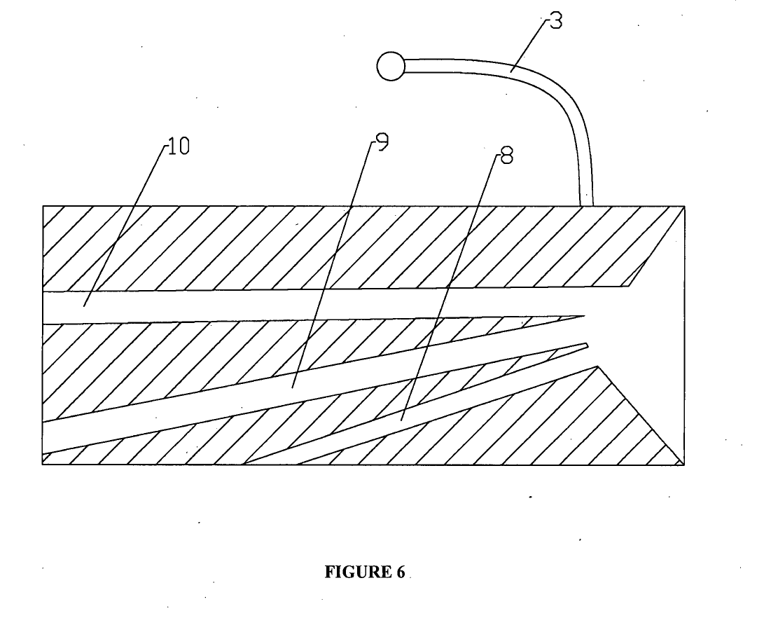

### DETAILED DESCRIPTION OF THE INVENTION

### i.) General Overview

The present invention relates to a novel anchor-preparing buccal tube. The buccal tube finds use in orthodontic treatment where it provides improved anchorage. The buccal tube described herein has at least one passage for receiving a main arch wire. The y angle between the passage and the molar occlusal plane is at least about −3° to tip back the molar tooth or prevent the molar tooth from tipping forward. The buccal tube can also include multiple passages that are intersecting on the buccal plane so that clinicians have the option to insert the main arch wire into any one of these passages to, again, tip back the molar(s) or prevent the molar(s) from tipping forward. As such, the anchorage is enhanced during orthodontic treatment.

### ii.) Definitions

The following definitions are set forth to illustrate and define the meaning and scope of the various terms used to describe the present invention.

The terms “molar” and “molar teeth” are used interchangeably herein and refer to the rearmost teeth in a mammal. Adult humans have twelve molars, in four groups of three at the back of the mouth. The third (rearmost) molar in each group is called a wisdom tooth. It is the last tooth to appear, breaking through the surface of the gum at about the age of twenty, although this varies by ethnicity. The types of molars in the human mouth are maxillary first molars, maxillary second molars, and maxillary third molars; and mandibular first molars, mandibular second molars, and mandibular third molars.

The term “buccal tube” refers to a small metal part that is affixed (e.g., welded) on the outside of a molar band or similar device (i.e., an orthodontic band or ring or similar device applied to a molar or premolar tooth). The buccal tube often contains openings (e.g., slots) to hold arch wires, lip bumpers, face bows and other orthodontic devices. The buccal tube may also be used in conjunction with treatment for teeth other than the molars.

The term “anchorage” refers to the resistance to activation force. Anchorage may come from intra-oral sources such as teeth, bone and soft tissue. Anchorage may come from extra-oral sources such as cervical (back of the neck), occipital (back of the head) and cranial (top of the head).

The term “anchor-preparing” means to provide for anchorage of the buccal tube to posterior teeth including molars and premolars.

The term “occlusion” describes the relationship of the maxillary and mandibular teeth as they are brought into functional contact.

The term “occlusal plane” refers to the imaginary surface on which upper and lower teeth meet in occlusion. It is actually a curved surface, but is commonly approximated by a plane (straight line in the lateral view) based on specific reference points within the dental arches.

The term “malocclusion” refers to the relationship of teeth in occlusion. It is a deviation in intramaxillary and/or intermaxillary relations of teeth from normal occlusion. Malocclusion is often associated with other dentofacial deformities according to the Angle classification of malocclusion introduced by Edward H. Angle. The governing criterion is the anteroposterior relationship of upper and lower first molars.

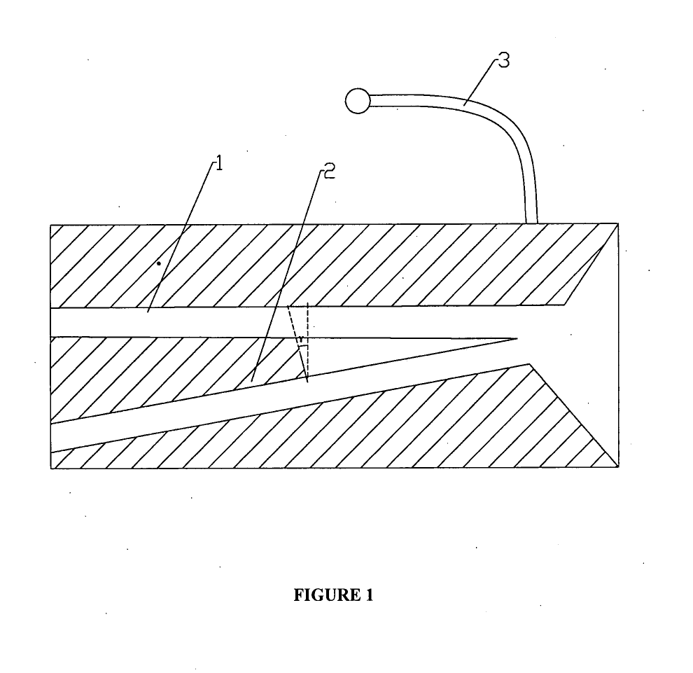

The term “γ angle” as used herein, refers to the angle between the vertical cross-section of a passage and the perpendicular line of Andrew's occlusal plane. For example, see FIG. 1 for an illustration of the γ angle. In FIG. 1, the γ angle is the angle between the vertical cross-section of the passage and the perpendicular line of the occlusal plane in a buccal tube. Thus, it is equal to the angle between the passage and the molar occlusal plane.

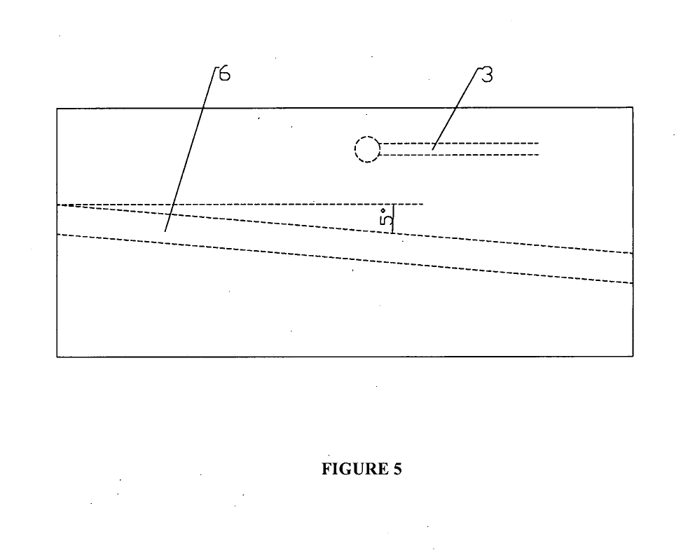

The term “anti-rotation angle” refers to the angle between the passages and the buccal side of the molar as shown in FIG. 5.

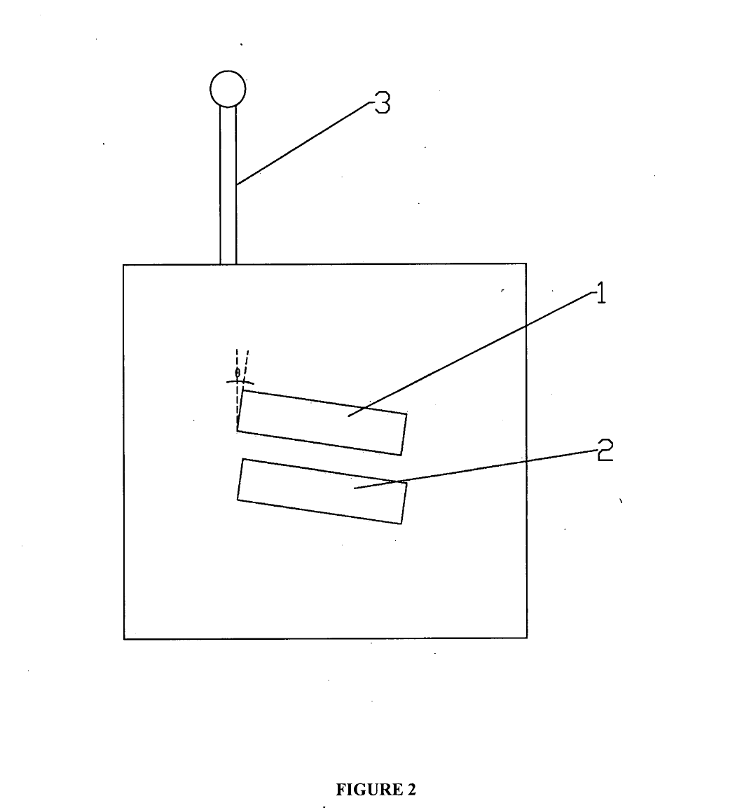

The term “angle θ” means, for the purpose of this invention, the angle between the side of a passage in a buccal tube facing the molar tooth and the buccal side of the molar tooth as shown in FIG. 2. The arch wire gives a force to the tooth at a desirable torque angle.

A “tip-back bend” is a bend on a wire to make the teeth tip backward or prevent the teeth from tipping forward.

A “band” refers to a thin ring or other device (e.g., metal ring, stainless steel ring), which serves to secure orthodontic attachments to a tooth. The band, with orthodontic attachments welded or soldered to it, is closely adapted to fit the contours of the tooth and then cemented into place.

### iii.) The Design

The present invention addresses an existing problem in orthodontics, namely that a tip-back bend cannot be made with a light-force wire (e.g., nickel-titanium wire or similar wire), particularly, while employing a technique wherein the wire is adjusted by hand by the orthodontist or clinician. This technique includes bending the wire to all necessary adjustments and not depending on prefabricated average adjustments. This technique is superior in both long term stability and esthetics when compared to the common practice of using prefabricated wires with pre-adjusted brackets. Preformed archwires that are prefabricated by machines to a few sizes and shapes are generally insufficient to maintain the original arch form and size. Notably, a tip-back bend is conventionally achieved with the use of stainless steel wires which are difficult to engage in brackets when teeth are irregular at the early stage of treatment. Stainless steel wires also provide a heavy force that is uncomfortable to patients and they slow down the teeth correction. In addition, they can also be aesthetically displeasing if too many bends are made on the wire in order to reduce the force. Thus, the invention provides a solution by providing a novel buccal tube that exhibits an anchor-preparing effect. The anchor-preparing effect achieves a tip-back bend with the use of light-force wires, particularly, while employing a technique wherein the wire is adjusted by hand by the orthodontist or clinician.

Thus, the novel buccal tube provides for a tip-back bend with a preformed, light-force and aesthetically pleasing no-bend nickel-titanium (Ni—Ti) wire that is widely used in the early stages of modern orthodontics to cause a tip back movement of the molar so that an anchorage preparation is possible without the use of stainless steel wire. When two or more passages are present in the buccal tube, light force Ni—Ti wires are inserted into the larger-negative-angle passage. This is done to first create tip back moment on the molar. During the treatment, the initial Ni—Ti wire will be slowly exchanged for a larger size Ni—Ti wire. As the Ni—Ti wire is changing to a larger size during treatment, the tip back movement increases to produce an anchorage preparation. When a molar tipping back is no longer needed, the orthodontist can insert an arch wire into another normal oriented passage to upright the molars as desired. The tip back movement during the early treatment stage will also help to enhance the anchorage even without the use of headgear. This is yet another advantage of the instant invention as the need of headgear will diminish for many patients.

The anchor-preparing buccal tube can include a single, double or triple passage. The most important attribute is that at least one passage that receives the main arch wire has a minus γ angle larger than −3° in order to tip-back the molar tooth. The γ angle is defined as the angle between the vertical cross-section of a passage and the perpendicular line of Andrews occlusal plane (supra). In orthodontics, the inclined angle of a tooth is defined as “plus” when the crown of the tooth is tipping forward and as “minus” when the crown of the tooth is tipping backward. This angle can also be interpreted as the angle between the passage of the buccal tube and the occlusal plane of the molar tooth. With a minus angle between the passage and the occlusal plane, the application of a nickel-titanium or similar wire provides the molar with a tipping back movement. Thus, the novel buccal tube provides for a tip-back bend with the use of nickel-titanium or similar wire which has so far not been possible. In comparison, the art has only achieved the tip-back bend via a stainless steel wire. If a stainless steel wire is used, then a tip-back bend can be achieved according to the Tweed Merrifield technique which provides for an anchor preparation in combination with the use of headgear (see Klontz H. A. (1996) Tweed-Merrifield Sequential Directional Force Treatment, Seminars in Orthodontics 2(4): 254-267). As pre-adjusted appliances are getting more popular, most angles which used to be made with wires are now made with brackets, so less bending is required in modern orthodontics, making the treatment of patients more convenient for orthodontists. But stainless steel wire is very stiff and it adds too much force when a plain stainless steel wire (i.e., no loop archwire) is engaged in the brackets. This is a particular disadvantage when the teeth are irregular. Ni—Ti arch wire is characterized by employing a light and continuous force which is more suitable for tooth movement. But in pre-adjusted appliances, angles made in the brackets usually reflect the normal position of teeth (the finished position) with an angle such as 5° for the upper first molar and 2° for the lower first molar. But these angles do not reflect the other angles such as those needed for anchor-preparing in the early stages of treatment. Thus, the novel buccal tube combines two angles, one for the finishing teeth position, and another for anchor preparation, this is achieved by arraying two cross passages in one buccal tube.

When a buccal tube with two passages (i.e., a double tube) is designed, the second passage is usually set at a regular angle, for example 0°. The two passages or their extension lines will eventually cross each other. Alternatively, the projections of the two passages will cross on the buccal side of the molar or in the sagittal plane of the head. One main difference of the novel buccal tube compared to a conventional tube is that in a conventional double tube one passage is for the main arch wire while the other passage is for the auxiliary arch wire or headgear. In the conventional double tube, the main arch wire and auxiliary arch wire may be used at the same time and they are always parallel to each other in a sagittal plane. In comparison, in the novel buccal tube both passages are designed to hold the main arch wire. Further, in the novel buccal tube the main archwire inserts into the passages at different treatment stages, one wire at a time. The significance of the two crossed passages in the novel buccal tube is that when a no-bend main archwire is inserted into the passage with the minus angle, it tips the molar back or prevents it from tipping forward. When tipping back is no longer needed, the main archwire can be inserted into the other passage with the regular angle. In order to achieve the same effect with a conventional tube, a tip-back bend would be needed which is nearly impossible to achieve with a Ni—Ti wire. The novel buccal tube can further include a headgear passage, i.e., two crossed main archwire passages and one headgear passage to enhance the anchorage. When triple tubes are designed, a conventional headgear tube is added to the double tube described above. Except for the headgear passage, the number of crossed passages can be more than 2.

In the present invention, the y angle can be about −3° to about −45°. This allows for the manufacture of single tubes with various different y angles so that orthodontists can choose different tubes according to the desired treatment. The same is true for double and triple tubes. The anti-rotation angle that is formed between the passages and the buccal side of the molar tooth can also be adjusted in the present invention. Usually, this angle is about 0° to about 30° to prevent molar mesial lingual rotation.

The passage of the novel buccal tube can have a round or rectangular cross-section. A rectangular cross-section will have a “torque angle” of about 0° to about −35° at the buccal side of the molar. In orthodontics, the inclination of a tooth in a buccal and lingual direction is known as the “torque angle”. Lingual tipping of the crown is defined as “minus” angle. The overall shape of the novel buccal tube is similar to a conventional buccal tube. It can be rectangular or trapezoid. The passages inside the buccal tube can be cylindrical, rectangular or differently shaped. The mesial entrance of the passages, especially when two or more passages cross anteriorly, can share one bell-mouthed opening. The novel buccal tube also has a conventional base for direct bonding to a molar buccal side or welding to a molar band. It can also have hooks for elastics and a headgear tube if desirable. The design of the passage can also be applied to the bracket for premolars and canines.

### iv.) Examples

The following specific example is intended to illustrate the invention and should not be construed as limiting the scope of the claims.

A patient with crowding teeth and anterior protusion is presented for orthodontic treatment. The extraction of four first premolars is required. The spaces of extraction are provided to relieve the anterior teeth from crowding and protrusion. The orthodontist wants to keep the molars in their original places. But when a retraction of the anterior teeth is done, the molars are usually used as an anchorage. To prevent molars from moving forward, the anchor-preparing double tubes can be bonded or bended on the molars. The beginning main archwire, for example, the light force Ni—Ti wire, is inserted into the passage with the minus angle that provides the molars a tip-back moment to prevent them form tipping forward. Because of the effects of the main archwire, teeth irregularity is reduced. A second and then a third main archwire, usually increasing in the diameter of the wire and in stiffness, replaces a previous wire (one at a time). While the wires put more and more force onto the irregular teeth, they also provide more and more moment to the molars to tip them back. This realizes the so-call anchorage preparation or at least prevents the molars from tipping forward according to the angle degree of the passage. When the orthodontist exchanges the last Ni—Ti wire for another working wire, usually a stainless steel rectangular wire, the molars will be in a tipping back position. This provides more resistant force to the anterior teeth retraction that is usually done by linking elastics between molars and anterior teeth. If the molar is still in a tipping back position after all the spaces have closed, then another passage with a regular angle can receive the main archwire to tilt the molar upright to a normal position. When maximum anchorage is required, a headgear can be used with a triple tube (supra). In this procedure, a stainless steel archwire with a tip-back bend and possible loops that are considered aesthetical displeasing and painful are replaced with a novel buccal tube with light force Ni—Ti wires with no-bend. This saves time for the orthodontist and provides a more pleasant experience for the patient while achieving a desirable result.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are understood by those skilled in the art are intended to be within the scope of the claims. All publications, patents and patent applications cited in this specification are herein incorporated by reference in their entirety.

What is claimed as new and desired to be protected by Letters Patent of the United States is:

1. An anchor-preparing buccal tube comprising at least one passage with an at least −3° γ angle between a molar occlusal plane and the passage.

2. The buccal tube of claim 1, wherein said y angle is between about −3° and about −45°.

3. The buccal tube of claim 1, wherein said γ angle is between about −5° and about −15°.

4. The buccal tube of claim 1, wherein said passage has an anti-rotation angle of about 0° to about 30° between said passage and a buccal side of a molar in a horizontal plane.

5. The buccal tube of claim 1, wherein said passage can be cylindrical or rectangular.

6. The buccal tube of claim 5, wherein said rectangular passage has a torque angle θ of about 0° to about −35°.

7. The buccal tube of claim 2, wherein said passage has an anti-rotation angle of about 0° to about 30° between said passage and a buccal side of a molar in a horizontal plane.

8. The buccal tube of claim 2, wherein said passage can be cylindrical or rectangular.

9. The buccal tube of claim 8, wherein said rectangular passage has a torque angle θ of about 0° to about −35°.

10. The buccal tube of claim 3, wherein said passage has an anti-rotation angle of about 0° to about 30° between said passage and a buccal side of a molar in a horizontal plane.

11. The buccal tube of claim 3, wherein said passage can be cylindrical or rectangular.

12. The buccal tube of claim 11, wherein said rectangular passage has a torque angle θ of about 0° to about −35°.
